(19) United States
(12) Patent Application Publication
(10) Pub. No.: US 2015/0071835 A1
(43) Pub. Date: Mar. 12, 2015

(54) NON-ADIABATIC CATALYTIC REACTOR

(71) Applicant: ZoneFlow Reactor Technologies, LLC, Windsor, CT (US)

(72) Inventor: Jonathan Jay Feinstein, North Salem, NY (US)

(73) Assignee: ZoneFlow Reactor Technologies, LLC

(21) Appl. No.: 14/481,473

(22) Filed: Sep. 9, 2014

Related U.S. Application Data
(60) Provisional application No. 61/960,071, filed on Sep. 9, 2013.

(51) Int. Cl. B01J 15/00; B01J 19/18

(52) U.S. Cl. CPC B01J 15/005; B01J 19/1862; B01J 2219/322; B01J 2219/32466
USPC 422/633; 422/222

(57) ABSTRACT

A non-adiabatic catalytic reactor for reacting a fluid includes a tube comprising an inlet, an outlet, a first wall, a diameter, a length, and a tube axis. The reactor also includes a plurality of structured packings disposed within the tube, and a plurality of mixing regions disposed within the tube. The structured packings and the mixed regions are arranged in an alternating pattern. Each structured packing includes one or more second walls defining channels for fluid flow through the structured packing, the channels being substantially parallel to the tube axis, the one or more second walls of the structured packing including a catalyst. At least one of the mixing regions permits mixing of first fluid proximate the first wall with second fluid farther from the first wall than the first fluid.

This application claims the benefit of U.S. Provisional Patent Application No. 61/960,071 filed on Sep. 9, 2013, which is hereby incorporated by reference in its entirety for all purposes.

### FIELD OF THE INVENTION

This specification relates generally to the field of catalytic reactors, and more particularly, to non-adiabatic catalytic reactors.

### BACKGROUND

Packed beds are most often preferred for adiabatic catalytic reactors at least partly because the particles in the bed are relatively inexpensive to produce and can be made to conform to vessels with large cross-sectional area to lower substantial pressure drops, where intentional heat transfer is not as highly valued as these other characteristics.

Structured packings in the form of honeycombs generally have the lowest ratio of pressure drop to mass transfer for situations where the cross-sectional area of the reactor is confined and low pressure drop is required, such as in the after treatment of exhaust from an engine. Honeycomb reactors are preferred in reactors of confined cross-section where heat transfer to increase the equilibrium constant of the given intended reaction is not substantial or intentional. Honeycombs generally are in the form of a catalytic coating on a substrate composed of ceramic or metal walls defining straight channels which are parallel to each other and to the axis of the reactor. Relatively high mass transfer is provided by using high cell density channels, i.e. low hydraulic diameter channels. Structured packings in the form of honeycombs provide poor heat transfer because they may increase the number of boundary layers between a fluid and a reactor wall by a factor of one hundred or more, where boundary layers are known to impede heat transfer.

In some processes, it is desirable to conduct endothermic or exothermic reactions substantially isothermally or to conduct endothermic reactions at progressively higher temperatures as in steam methane reforming or exothermic reactions at progressively lower temperatures as in methanol synthesis from mixtures of hydrogen and carbon monoxide or in ammonia synthesis from mixtures of hydrogen and nitrogen or as in hydrogenation, methanation, or water gas shift reactions. In such processes, defined herein as non-adiabatic, some amount of intentional heat transfer is needed.

Packed beds have been preferred historically for non-adiabatic catalytic reactors at least partly because packed beds are generally less expensive than structured packings. Packed beds of extruded pellets can also have thick walls and higher concentrations of kinetically active ingredients to contain higher catalyst surface area than structured packings, which is advantageous for processes limited or controlled by the kinetic rates of the reaction sites as opposed to the rate of heat transfer or mass transfer to or from the reaction sites. Packed beds also induce turbulence and fluid flow against reactor walls to break down boundary layers that would otherwise impede heat transfer, which is desirable in processes controlled or limited by heat transfer.

More recently, it has been found that structured packings can be engineered to provide a higher ratio of heat transfer to pressure drop than packed beds in similar catalytic processes. For example, U.S. Pat. Nos. 7,976,783 and 8,235,361 show examples of such structured catalytic packings. However, these and other structured packings and packed beds have undesirably high ratios of pressure drop to mass transfer between the bulk fluid and the reaction sites, herein referred to as mass transfer.

Some structured packings with channels parallel to the reactor axis have been proposed for processes controlled by heat transfer. For example, U.S. Pat. Nos. 7,501,102, 7,682,580, and 7,906,079 describe structured packings which incorporate straight channels parallel to the reactor axis in a non-adiabatic reactor, but each of those described apparatus entails blockage or masking of a significant part of the reactor cross-section to increase the fluid velocity and thereby increase the heat transfer into the reactor for the steam methane reforming process.

U.S. Pat. No. 7,087,192 describes the well-known method of repeating the steps of (a) heating a fluid in tubes with a large ratio of surface area to volume and (b) reacting the fluid adiabatically in a packed bed. U.S. Pat. Nos. 4,098,589, 4,203,950, and 6,818,028 describe systems for achieving an endothermic reaction of a fluid in a non-adiabatic catalytic reactor against heat from a flue gas in tubes containing packed beds. U.S. Pat. No. 7,094,363 also describes various systems but with tubes that may contain either pellets or structured elements, where structured elements are “monoliths, cross corrugated, straight-channeled, foams, plates, structures attached to the tube wall, or other suitable shapes”. U.S. Pat. Nos. 7,371,361, 7,842,254, 7,846,412 and US patent applications 20060099131, 20080056964, and 20080107585 discuss non-adiabatic catalytic reactors for exothermic reactions in which tubes contain alternating catalytically active zones separated by catalytically limited zones.

In many cases, structured packings achieve improved heat transfer compared to packed beds by using measures to increase pressure drop to levels almost as high or as high as in packed beds for applications controlled by heat transfer.

### SUMMARY

In accordance with an embodiment, a non-adiabatic catalytic reactor for reacting a fluid is provided. The reactor includes a tube comprising an inlet, an outlet, a first wall, a diameter, a length, and a tube axis. The reactor also includes a plurality of structured packings disposed within the tube, and a plurality of mixing regions disposed within the tube. The structured packings and the mixed regions are arranged in an alternating pattern. Each structured packing includes one or more second walls defining channels for fluid flow through the structured packing, the channels being substantially parallel to the tube axis, the one or more second walls of the structured packing including a catalyst. At least one of the mixing regions permits mixing of first fluid proximate the first wall with second fluid farther from the first wall than the first fluid.

In another embodiment, the structured packing has a length greater than 0.2 times a diameter of the tube and less than 20 times the diameter of the tube.

In another embodiment, the structured packing has a length greater than 0.5 times the diameter of the tube and less than 8 times the diameter of the tube.

In another embodiment, the mixing region has a length greater than 0.2 times a diameter of the tube and less than 30 times the diameter of the tube.

In another embodiment, the mixing region has a length greater than the diameter of the tube and less than 10 times the diameter of the tube.

In another embodiment, the structured packing has a geometric surface area (GSA) less than 500 m²/m³.

In another embodiment, the one or more second walls of the structured packing have a thickness less than 1.5 mm.

In another embodiment, the structured packing has an open face area greater than 60%.

In another embodiment, the structured packing has an open face area greater than 80%.

In another embodiment, the mixing regions are substantially empty.

In another embodiment, the mixing regions contain a static mixer.

In another embodiment, the reactor is used to reform a hydrocarbon having one of steam and carbon dioxide against the heat of a flue gas or process gas.

In another embodiment, the reactor comprises at least 3 structured packings.

In accordance with another embodiment, a non-adiabatic catalytic reactor for reacting a fluid is provided. The reactor includes a tube having an inlet, an outlet, a first wall, a diameter, and a tube axis. The reactor also includes a structured packing disposed within the tube, wherein the structured packing comprises one or more second walls defining one or more channels for fluid flow through the structured packing, the one or more walls comprising a catalyst, wherein the angle between a first line parallel to an axis of the one or more channels and a second line parallel to the tube axis is less than 45°.

In another embodiment, the angle is less than 30°.

In another embodiment, the angle is less than 15°.

In another embodiment, the angle is less than 8°.

In another embodiment, the packing has a geometric surface area (GSA) of less than 500 m²/m³.

In another embodiment, the one or more second walls of the structured packing have a thickness of less than 1.5 mm.

In another embodiment, the structured packing has an open face area of greater than 60%.

In another embodiment, the structured packing has an open face area of greater than 80%.

In another embodiment, at least one of the one or more channels communicates with the tube wall.

In another embodiment, a first one of the one or more channels directs fluid flowing from the inlet to the outlet toward the tube wall and a second one of the one or more channels directs the fluid away from the tube wall.

In another embodiment, the reactor is used to reform a hydrocarbon having one of steam and carbon dioxide against the heat of a flue gas or process gas.

In another embodiment, the reactor comprises at least 3 structured packings.

These and other advantages of the present disclosure will be apparent to those of ordinary skill in the art by reference to the following Detailed Description and the accompanying drawings.

### BRIEF DESCRIPTION OF THE DRAWINGS

FIG. 1A shows a longitudinal cross-section of a reactor in accordance with an embodiment;

FIG. 1B shows a longitudinal cross-section of a reactor in accordance with another embodiment;

FIG. 2A shows a transverse cross-section of a reactor in accordance with another embodiment;

FIGS. 2B and 2C show longitudinal respective cross-sections of the reactor of FIG. 2A;

FIG. 3A shows a transverse cross-section of a reactor in accordance with another embodiment;

FIG. 3B shows a transverse cross-section of a reactor in accordance with another embodiment; and

FIG. 3C shows a transverse cross-section of a reactor in accordance with another embodiment.

### DETAILED DESCRIPTION

The following Detailed Description discloses various exemplary embodiments and features. These exemplary embodiments and features are not intended to be limiting.

As discussed above, existing reactor systems exhibit multiple disadvantages including high pressure drop, low geometric surface area (“GSA”), low OFA, and low mass transfer. The present specification describes catalytic structured packings for non-adiabatic uses designed to improve mass transfer at low pressure drop, while incorporating components normally considered unsuitable for heat transfer in other contexts.

Systems, methods and apparatus described herein pertain to a unique reactor design that substantially reduces one or more of the disadvantages of existing systems and methods for non-adiabatic catalytic reactors limited or controlled by mass transfer. Those disadvantages include poor mass transfer, low conversion, high pressure drop, high capital costs of multiple alternating heat exchangers and catalytic reactors, high reactor volume, high reactor cross-section, channeling, and crushing. The systems, methods, and apparatus described herein provides a lower pressure drop solution than previously known for non-adiabatic catalytic reactors, particularly those controlled by mass transfer. The present specification will make other advantages apparent to one skilled in the art.

As used herein, the following terms shall have the indicated meanings:

A packed bed is a reactor containing multiple randomly oriented particles of any desired shape.

A catalytic packed bed is a packed bed in which the particles contain or include one or more catalysts useful for the intended purpose.

A structured packing, sometimes referred to as an engineered packing, is a monolithic structure containing walls with regular, repetitive dimensions in fixed orientation (as opposed to a packed bed or foam). The walls define flow channels for directing the flow of a fluid through the packing and may be pervious, impervious or perforated.

Catalytic structured packings are structured packings that contain or include one or more catalysts useful for the intended purpose.

Geometric surface area (GSA) is the macroscopic surface area of a solid shape or substrate that holds or supports a catalyst in a reactor divided by the volume of the reactor. GSA does not include the additional surface area contributed by generally microscopic or small surface roughness or porosity. GSA, as used herein, is measured in units of m² of surface area per m³ of reactor volume.

Open face area, i.e. “OFA” is the average percentage of the cross-sectional area of a reactor that is void and available for flow of a fluid from the inlet to the outlet of the reactor. In certain embodiments, the volume within a hollow structure that is partially or fully blocked to the flow of fluid through the structure at some point along the length of the structure from its inlet to its outlet is partially or fully excluded from the open face area. For example, the cross-section within an empty can or cylinder within a reactor wherein the axis of the can or cylinder is aligned with the axis of the reactor and one end of the can or cylinder is blocked to flow by a wall that is perpendicular to the reactor axis is not included in the open face cross-sectional area for any transverse cross-section of the reactor intersecting the can or cylinder.

A tube may have any cross-sectional shape. A housing through which a fluid flows is considered for the purposes of the present specification to be a tube.

A single tube refers to a length of tube as a discreet container for a reactor as distinct from a series of tubes wherein each tube contains a reactor and the respective tubes in the series of tubes or containers reside in, or are separated by, different heating or cooling environments, such as in the use of both a close-coupled and a floor-mounted automobile exhaust catalyst.

Tube diameter refers to the inside hydraulic diameter of a tube.

A non-adiabatic catalytic reactor refers to a catalytic reactor for an endothermic reaction that is externally heated to cause fluid exiting the reactor to have a temperature substantially the same as or hotter than the temperature of the fluid entering the reactor. A non-adiabatic reactor also refers to a catalytic reactor for an exothermic reaction that is externally cooled to cause fluid exiting the reactor to have a temperature substantially the same as or cooler than the temperature of the fluid entering the reactor. Environmental catalytic reactors employed to convert pollutants into non-polluting species via exothermic reactions and which experience incidental heat losses to the ambient atmosphere are excluded from this definition.

Catalyst surface area refers to the Brunauer-Emmett-Teller (BET) surface area of the kinetically active substance in a catalytic reactor.

In accordance with an embodiment, a non-adiabatic catalytic reactor includes one or more catalytic structured packings residing within a single tube. In other embodiments, an array of tubes operating in parallel may be used.

In one embodiment, the tube has an inlet, an outlet, a wall, a diameter, a length, and a tube axis. The packing contains walls that define multiple discontinuous channels for the flow of fluid through the channels. Each channel has an axis. The walls contain a suitable catalyst. Between the channels the fluid consecutively passes through from the tube inlet to tube outlet are volumes that communicate with the tube wall.

The GSA of the packing is preferably less than 500 m²/m³ and is more preferably less than 250 m²/m³. The GSA may include a catalytic coating on the inside of the tube, or the inside of the tube may be uncoated.

The OFA of the packing is preferably greater than 60% and more preferably greater than 80%. The walls of the packing are preferably less than 1 mm thick.

If the packing does not fill the entire cross-section of the tube such that there is a gap between the packing and the tube, the fluid exiting the packing communicates with and mixes with the fluid passing in parallel between the packing and the tube.

In a first embodiment, the reactor consists of at least 3, preferably at least 5, and more preferably at least 10 catalytic structured packings arranged in series along the length of a tube. The axes of the channels are parallel to the tube axis. The length of the individual structured packings is preferably greater than 0.2 and less than 20 times the tube diameter and is more preferably greater than 0.5 and less than 8 times the tube diameter.

Between consecutive catalytic structured packings are mixing regions that are empty or contain other structures, such as one or more static mixers, catalytic or non-catalytic structured packings or packed beds. The mixing regions permit mixing of the fluid nearer the tube wall with fluid more remote from the tube wall to increase and distribute the flow of heat between the tube wall and the fluid. The mixing regions may be empty or contain a structured packing. The length of the mixing regions is preferably greater than 0.2 and less than 30 times the tube diameter, and is more preferably greater than 1 and less than 10 times the tube diameter.

In another embodiment, the reactor consists of a single catalytic structured packing within a tube. The channel axes are at an oblique angle to a line, which line is parallel to the tube axis and intersects the channel axis. Preferably, the channel axes are at an oblique angle to the tube axis such that the channels direct fluid passing through them from the tube inlet to the tube outlet in a radial direction alternatingly toward and away from the tube wall. The oblique angle is preferably less than 45°, more preferably less than 30°, most preferably less than 15° and especially less than 8°. General arrangements of walls and channels are described in U.S. Pat. Nos. 7,566,487 and 7,976,783, which are incorporated into the present disclosure in their entirety by reference.

Preferably, a first one or more of the oblique channels are centripetal channels, having inlets nearer the tube and outlets more remote from the tube and a second one or more oblique channels are centrifugal channels, having inlets more remote from the tube and outlets nearer the tube. Fluid exiting oblique channels directed centrifugally as the fluid passes from the tube inlet to the tube outlet tends to impinge the tube, while the oblique, centripetal channels provide paths for the fluid to return from the tube. Preferably all channels are of the same cross-section and length, the magnitude of the centripetal and centrifugal angles to the tube axis are the same, and there are equal numbers of centripetal and centrifugal channels.

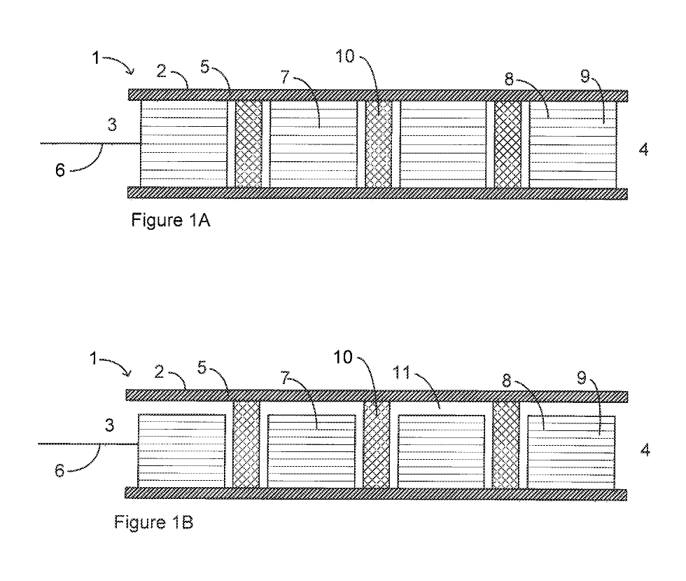

FIG. 1A shows a reactor 1 that includes a tube 2 having an inlet 3, an outlet 4, walls 5, and an axis 6. The tube 2 contains multiple modules, referred to as catalytic structured packings 7, including walls 8 that define flow channels 9. The walls 8 and channels 9 of the packing 7 are parallel to the tube axis. Between the packings 7 are static mixers 10 (shown as checkered areas) which cause fluid from different flow channels of a packing 7 to mix with fluid from other channels of the same packing 7 before entering the next packing 7 as the fluid passes from the inlet 3 to the outlet 4 of the tube 2. Fluid passes through tube 2 from inlet 3 to outlet 4 and through successive alternating structured packings 7 and static mixers 10.

FIG. 1B shows reactor 1 in accordance with another embodiment. A gap 11 separates the top of a structured packing 7 from the tube 2. Fluid passing from inlet 3 to outlet 4 that passes through gap 11 communicates with and mixes with fluid that passes in parallel through the associated packings.

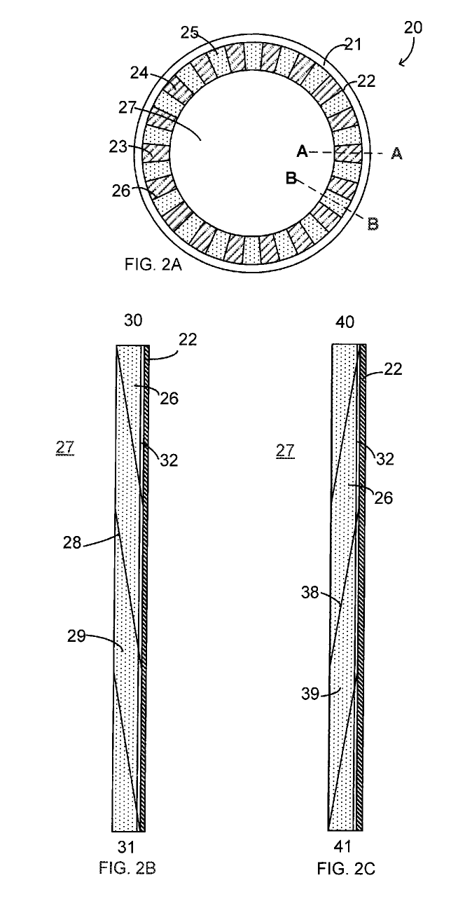

FIG. 2A shows a transverse cross-section of a reactor 20 in accordance with another embodiment. A tube 21 has a wall 22 containing a structured packing 23. The packing 23 includes a plurality of centrifugal columns 24 (shown as cross hatched areas in FIG. 2A) and a plurality of centripetal columns 25 (shown as dotted areas in FIG. 2A). In the illustrative embodiment of FIG. 2A, centrifugal columns 24 and centripetal columns 25 are arranged in an alternating pattern. Adjacent columns are separated by radial walls 26. In one embodiment, there are gaps (not shown) between the radial walls 26 and the tube wall. The gaps between walls 26 and tube 21 may be uniform in width, non-uniform in width, and/or intermittently spaced along the tube's axial direction. Fluid passing from the inlet to the outlet of tube 21 passes in parallel through centrifugal and centripetal columns. A central volume 27 near the tube axis is void of structures. Dotted line A-A represents a first plane that contains the central axis of the tube and passes through a centrifugal column 24 of the packing. Dotted line B-B represents a plane that contains the central axis of the tube and passes through a centripetal column 25 of the packing.

FIG. 2B is longitudinal cross-section of the tube defined by the first plane A-A shown in FIG. 2A. Packing walls 28 define channels 29. Walls 28 are at an oblique angle to the axis of the tube. Fluid passing through the channels from an inlet 30 to an outlet 31 of the tube is directed centrifugally toward the tube wall 22. Radial wall 26 (not in plane A-A), shown as a dotted area in FIG. 2B, separates adjacent centrifugal and centripetal columns. A gap 32 separates the radial wall 26 and the tube wall 22. Fluid exiting a centrifugal channel near the tube wall flows circumferentially through the gap into a centripetal channel of an adjacent centripetal column. Volume 27 shown in FIG. 2B represents the central volume 27 of the reactor 20.

FIG. 2C is a longitudinal cross-section along the tube defined by the second plane B-B of FIG. 2A. Packing walls 38 define channels 39. Walls 38 are at an oblique angle to the tube axis. Fluid passing through the channels from an inlet 40 to an outlet 41 of the tube is directed centripetally away from the tube wall 22. Radial wall 26 (not in plane B-B), shown as a dotted area in FIG. 2C, separates adjacent centrifugal and centripetal columns. A gap 32 separates the radial wall 26 and the tube wall 22. Volume 27 shown in FIG. 2C represents the central volume 27 of the reactor 20.

In the embodiment of FIGS. 2A, 2B, and 2C, the channels 29 and 39 in the packing communicate with the central volume 27 and with the tube wall. In other embodiments, the central volume 27 may optionally contain one or more structured packings or static mixers. The open face area of the cross-section of the entire reactor is at least 60% and preferably at least 80%. The angle of the walls 28 and 38 with respect to the tube axis is preferably less than 45°, more preferably less than 30°, more preferably less than 15° and most preferably less than 8°.

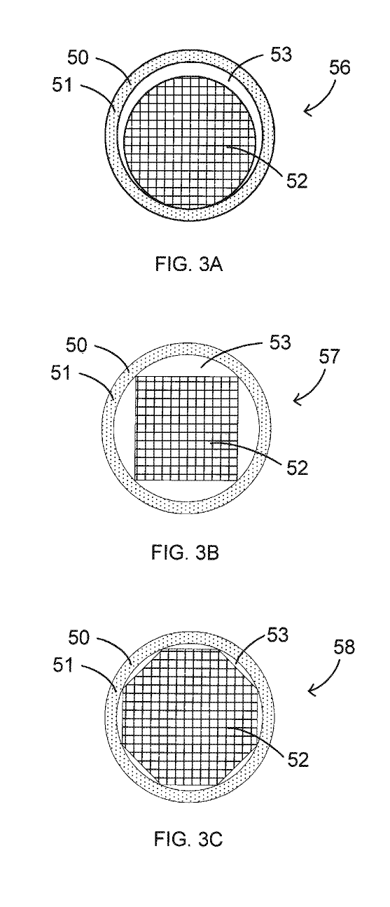

FIG. 3A shows a transverse cross-section of a reactor 56 in accordance with another embodiment. FIG. 3B shows a transverse cross-section of a reactor 57 in accordance with another embodiment. FIG. 3C shows a transverse cross-section of a reactor 58 in accordance with another embodiment. In each of FIGS. 3A, 3B, and 3C, a tube 50 having a cylindrical wall 51 contains a catalytic structured packing 52 (shown as a checkered area). Between the packing 52 and tube 50 is a gap 53. In FIG. 3A, the gap 53 separates tube 50 and a circular packing 52 lying inside the bottom of a horizontal tube. In FIG. 3B, the gap 53 separates tube 50 and a square packing 52. In FIG. 3C, the gap 53 separates tube 50 and a packing 52 having a selected shape. The packing 52 and the gap 53 between the packing and tube wall may have other shapes not shown in FIGS. 3A-3C.

In accordance with an embodiment, the reactor is a catalytic reactor for pre-reforming a hydrocarbon with steam or carbon dioxide. The wall of the packing is composed of a substrate coated with a catalyst. The substrate is preferably metal, and most preferably stainless steel sheet or foil containing about 21% Cr and 4-6% Al, such as Aluchrome™ or Fecralloy™. The substrate may alternatively be a refractory material. The coating may be an alumina based support containing Ni, a platinum group metal, or other suitable material as the active catalyst.

The thickness of a coated wall of the packing is less than 1.5 mm and preferably less than 0.5 mm. The open face area is preferably greater than 60% and more preferably greater than 80%. The reactor is externally heated against flue gas from a furnace or against hot process gas containing hydrogen and carbon monoxide. The reactor contains at least 3, preferably at least 5, and more preferably at least 10 catalytic packings in alternating sequence with mixing regions in which mixing regions fluids exiting the various channels of the respective structured packings mix with each other.

Thus, in accordance with an embodiment, a non-adiabatic catalytic reactor for reacting a fluid is provided. The reactor includes a tube comprising an inlet, an outlet, a first wall, a diameter, a length, and a tube axis. The reactor also includes a plurality of structured packings disposed within the tube, and a plurality of mixing regions disposed within the tube. The structured packings and the mixing regions are arranged in an alternating pattern. Each structured packing includes one or more second walls defining channels for fluid flow through the structured packing, the channels being substantially parallel to the tube axis, the one or more second walls of the structured packing including a catalyst. At least one of the mixing regions permits mixing of first fluid proximate the first wall with second fluid farther from the first wall than the first fluid.

In another embodiment, the structured packing has a length greater than 0.2 times a diameter of the tube and less than 20 times the diameter of the tube.

In another embodiment, the structured packing has a length greater than 0.5 times the diameter of the tube and less than 8 times the diameter of the tube.

In another embodiment, the mixing region has a length greater than 0.2 times a diameter of the tube and less than 30 times the diameter of the tube.

In another embodiment, the mixing region has a length greater than the diameter of the tube and less than 10 times the diameter of the tube.

In another embodiment, the structured packing has a geometric surface area (GSA) less than 500 m²/m³.

In another embodiment, the one or more second walls of the structured packing have a thickness less than 1.5 mm.

In another embodiment, the structured packing has an open face area greater than 60%.

In another embodiment, the structured packing has an open face area greater than 80%.

In another embodiment, the mixing regions are substantially empty.

In another embodiment, the mixing regions contain a static mixer.

In another embodiment, the reactor is used to reform a hydrocarbon having one of steam and carbon dioxide against the heat of a flue gas or process gas.

In another embodiment, the reactor comprises at least 3 structured packings.

In accordance with another embodiment, a non-adiabatic catalytic reactor for reacting a fluid is provided. The reactor includes a tube having an inlet, an outlet, a first wall, a diameter, and a tube axis. The reactor also includes a structured packing disposed within the tube, wherein the structured packing comprises one or more second walls defining one or more channels for fluid flow through the structured packing, the one or more walls comprising a catalyst, an angle between a first line parallel to an axis of the one or more channels and a second line parallel to the tube axis being less than 45°.

In another embodiment, the angle is less than 30°.

In another embodiment, the angle is less than 15°.

In another embodiment, the angle is less than 8°.

In another embodiment, the packing has a geometric surface area (GSA) of less than 500 m²/m³.

In another embodiment, the one or more second walls of the structured packing have a thickness of less than 1.5 mm.

In another embodiment, the structured packing has an open face area of greater than 60%.

In another embodiment, the structured packing has an open face area of greater than 80%.

In another embodiment, at least one of the one or more channels communicates with the tube wall.

In another embodiment, a first one of the one or more channels directs fluid flowing from the inlet to the outlet toward the tube wall and a second one of the one or more channels directs the fluid away from the tube wall.

In another embodiment, the reactor is used to reform a hydrocarbon with one of steam and carbon dioxide against the heat of a flue gas or process gas.

In another embodiment, the reactor comprises at least 3 structured packings.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A non-adiabatic catalytic reactor for reacting a fluid, the reactor comprising:
a tube comprising an inlet, an outlet, a first wall, a diameter, a length, and a tube axis;
a plurality of structured packings disposed within the tube; and
a plurality of mixing regions disposed within the tube;
wherein:
the structured packings and the mixed regions are arranged in an alternating pattern;
each structured packing includes one or more second walls defining channels for fluid flow through the structured packing, the channels being substantially parallel to the tube axis, the one or more second walls of the structured packing including a catalyst; and
at least one of the mixing regions permits mixing of first fluid proximate the first wall with second fluid farther from the first wall than the first fluid.

2. The reactor of claim 1, wherein the structured packing has a length greater than 0.2 times a diameter of the tube and less than 20 times the diameter of the tube.

3. The reactor of claim 2, wherein the structured packing has a length greater than 0.5 times the diameter of the tube and less than 8 times the diameter of the tube.

4. The reactor of claim 1, wherein the mixing region has a length greater than 0.2 times a diameter of the tube and less than 30 times the diameter of the tube.

5. The reactor of claim 4, wherein the mixing region has a length greater than the diameter of the tube and less than 10 times the diameter of the tube.

6. The reactor of claim 1, wherein the structured packing has a geometric surface area (GSA) less than 500 m²/m³.

7. The reactor of claim 1, wherein the one or more second walls of the structured packing have a thickness less than 1.5 mm.

8. The reactor of claim 1, wherein the structured packing has an open face area greater than 60%.

9. The reactor of claim 8, wherein the structured packing has an open face area greater than 80%.

10. The reactor of claim 1, wherein the mixing regions are substantially empty.

11. The reactor of claim 1, wherein the mixing regions contain a static mixer.

12. The reactor of claim 1, wherein the reactor is used to reform a hydrocarbon with one of steam and carbon dioxide against heat of a flue gas or process gas.

13. The reactor of claim 1, wherein the reactor comprises at least 3 structured packings.

14. A non-adiabatic catalytic reactor for reacting a fluid, the reactor comprising:
a tube having an inlet, an outlet, a first wall, a diameter, and a tube axis; and
a structured packing disposed within the tube, wherein the structured packing comprises one or more second walls defining one or more channels for fluid flow through the structured packing, the one or more walls comprising a catalyst, an angle between a first line parallel to an axis of the one or more channels and a second line parallel to the tube axis being less than 45°.

15. The reactor of claim 14, wherein the angle is less than 30°.

16. The reactor of claim 15, wherein the angle is less than 15°.

17. The reactor of claim 16, wherein the angle is less than 8°.

18. The reactor of claim 14, wherein the structured packing has a geometric surface area (GSA) of less than 500 m²/m³.

19. The reactor of claim 14, wherein the one or more second walls of the structured packing have a thickness of less than 1.5 mm.

20. The reactor of claim 14, wherein the structured packing has an open face area of greater than 60%.

21. The reactor of claim 20, wherein the structured packing has an open face area of greater than 80%.

22. The reactor of claim 14, wherein at least one of the one or more channels communicates with the tube wall.

23. The reactor of claim 14, wherein a first one of the one or more channels directs fluid flowing from the inlet to the outlet toward the tube wall and a second one of the one or more channels directs the fluid away from the tube wall.

24. The reactor of claim 14, wherein the reactor is used to reform a hydrocarbon with one of steam and carbon dioxide against heat of a flue gas or process gas.

25. The reactor of claim 14, wherein the reactor comprises at least 3 structured packings.
